(19) United States
(12) Patent Application Publication
(10) Pub. No.: US 2026/0261351 A1
(43) Pub. Date: Sep. 3, 2026

(54) DATA PROCESSING METHOD, TERMINAL, AND READABLE STORAGE MEDIUM

(71) Applicant: ZTE CORPORATION, Shenzhen, Guangdong (CN)

(72) Inventors: Wenbin LI, Shenzhen, Guangdong (CN); Zhanyi DONG, Shenzhen, Guangdong (CN); Wei LIN, Shenzhen, Guangdong (CN); Hua RUI, Shenzhen, Guangdong (CN)

(21) Appl. No.: 18/879,826

(22) PCT Filed: Aug. 15, 2023
(86) PCT No.: PCT/CN2023/113108

§ 371 Date: Dec. 30, 2024

(30) Foreign Application Priority Data
Sep. 6, 2022 (CN) 202211084695.7

(51) Int. Cl. H04B 17/309; H04L 25/02

(52) U.S. Cl. CPC H04B 17/346; H04L 25/0224

(57) ABSTRACT

The present application relates to the field of communications, and discloses a data processing method and apparatus, and a terminal. The data processing method in embodiments of the present application comprises: performing spatial decomposition on received data of a plurality of receiving antennas to obtain a plurality of sub-spaces; measuring the signal quality of at least one sub-space; selecting a target sub-space from the plurality of sub-spaces according to the signal quality of the sub-space; and processing the received data by means of the target sub-space.

### CROSS-REFERENCE TO RELATED APPLICATIONS

The present application claims priority to Chinese Patent Application No. 202211084695.7, filed to the China Patent Office on Sep. 6, 2022 and entitled “DATA PROCESSING METHOD, TERMINAL, AND READABLE STORAGE MEDIUM”, the entire content of which is incorporated herein by reference.

### TECHNICAL FIELD

Embodiments of the present application relate to the field of communications, in particular to a data processing method, a terminal, and a readable storage medium.

### BACKGROUND

With surge in the number of wireless network access devices, various wireless services are flourishing, the 5th-generation mobile communication technology (5G), as a broadband mobile communication technology characterized by a high speed, a low delay and a massive connection, provides an ultimate experience for mobile Internet users.

A massive multiple-input multiple-output (Massive MIMO) technology, as one of key technologies of the 5G, configures a large number of antennas on a base station side and is capable of supporting access of a large number of wireless network devices at the same time. A receiver, when processing data received by a large scale of antennas, adopts a manner of processing all data of all receiving antennas respectively, such as front-end processing, channel estimation, equalization, demodulation and bit-level processing. Thus, energy consumption and data processing complexity of the receiver are large.

### SUMMARY

Embodiments of the present application provide a data processing method, a terminal, and a readable storage medium, which can solve the problem of large energy consumption and data processing complexity of a receiver.

In a first aspect, a data processing method is provided, including: performing spatial decomposition on received data of a plurality of receiving antennas to obtain a plurality of sub-spaces; measuring signal quality of at least one sub-space; selecting a target sub-space from the plurality of sub-spaces according to the signal quality of the sub-space; and processing the received data by means of the target sub-space.

In a second aspect, a data processing apparatus is provided, including: a decomposition module, configured to perform spatial decomposition on received data of a plurality of receiving antennas to obtain a plurality of sub-spaces; a measurement module, configured to measure signal quality of at least one sub-space; a selection module, configured to select a target sub-space from the plurality of sub-spaces according to the signal quality of the sub-space; and a processing module, configured to process the received data by means of the target sub-space.

In a third aspect, a terminal is provided and includes a processor and a memory, the memory stores a program or an instruction capable of running on the processor, and the program or the instruction, when executed by the processor, implements the steps of the method described in the first aspect.

In a fourth aspect, a readable storage medium is provided and stores a program or an instruction, and the program or the instruction, when executed by a processor, implements the steps of the method described in the first aspect.

In a fifth aspect, a chip is provided and includes a processor and a communication interface, the communication interface is coupled to the processor, and the processor is configured to run a program or an instruction to implement the method described in the first aspect.

In a sixth aspect, a computer program/program product is provided and stored in a storage medium and implements, when executed by at least one processor, the steps of the data processing method described in the first aspect.

In the embodiments of the present application, the spatial decomposition is performed on the received data of the plurality of receiving antennas to obtain the plurality of sub-spaces; the signal quality of the at least one sub-space is measured; the target sub-space is selected from the plurality of sub-spaces according to the signal quality of the sub-space; and the received data is processed by means of the target sub-space.

### BRIEF DESCRIPTION OF DRAWINGS

FIG. 1 shows a schematic diagram of a wireless communications system to which an embodiment of the present application can be applied.

FIG. 2 to FIG. 5 show a schematic flowchart of a data processing method provided by an embodiment of the present application.

FIG. 6 shows a schematic structural diagram of a data processing apparatus provided by an embodiment of the present application.

FIG. 7 shows a schematic structural diagram of a terminal provided by an embodiment of the present application.

### DETAILED DESCRIPTION

The technical solutions in embodiments of the present application are clearly described in the following with reference to the accompanying drawings in the embodiments of the present application. Apparently, the described embodiments are some rather than all of the embodiments of the present application. All other embodiments obtained by those ordinarily skilled in the art based on the embodiments in the present application fall within the protection scope of the present application.

Terms such as “first” and “second” in the specification and claims of the present application are used to distinguish similar objects, but are not used to describe a specific sequence or sequential order. It is to be understood that terms used in this way are exchangeable in a proper case, so that the embodiments of the present application can be implemented in an order different from the order shown or described herein. Objects distinguished by “first” and “second” are usually of the same type, and the number of objects is not limited, for example, there may be one first object or a plurality of first objects. In addition, “and/or” used in this specification and the claims represents at least one of the connected objects. A character “/” generally represents an “or” relationship between associated objects before and after the character.

It is worth noting that the technologies described in the embodiments of the present application are not limited to a long term evolution (LTE)/LTE-advanced (LTE-A) system, and may also be applied to other wireless communication systems, such as a code division multiple access (CDMA), a time division multiple access (TDMA), a frequency division multiple access (FDMA), an orthogonal frequency division multiple access (OFDMA), a single-carrier frequency-division multiple access (SC-FDMA) and other systems. Terms such as “system” and “network” in the embodiments of the present application are frequently used interchangeably, and the described technologies may be not only used for the above-mentioned systems and a radio technology, but also used for other systems and radio technologies. The following description describes a new radio (NR) system for the purpose of an example, an NR term is used in most of the following descriptions, but these technologies may also be applied to an application other than an NR system application, such as a 6th generation (6G) communication system.

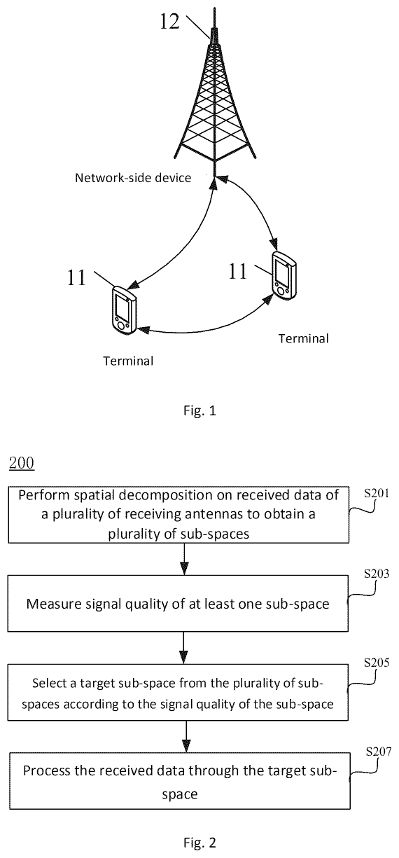

FIG. 1 shows a schematic diagram of a wireless communications system to which an embodiment of the present application can be applied. The wireless communication system includes a terminal 11 and a network-side device 12. The terminal 11 may be a mobile phone, a tablet personal computer, a laptop computer which is alternatively called a notebook computer, a personal digital assistant (PDA), a palmtop computer, a netbook, an ultra-mobile personal computer (UMPC), a mobile Internet device (MID), an augmented reality (AR)/virtual reality (VR) device, a robot, a wearable device, vehicle user equipment (VUE), pedestrian user equipment (PUE), a smart home (a household device having a wireless communication function, such as a refrigerator, a television, a washing machine or furniture), a game machine, a personal computer (PC), a teller machine, a self-service machine or other terminal-side devices, and the wearable device includes: a smart watch, a smart bracelet, smart earphones, smart glasses, smart jewelry (a smart bracelet, a smart chain bracelet, a smart ring, a smart necklace, a smart anklet, a smart anklet chain or the like), a smart wristband, smart clothing or the like. It needs to be noted that the specific type of the terminal 11 is not limited in the embodiments of the present application. The network-side device 12 may include an access network device or a core network device. The access network device 12 may also be called a wireless access network device, a radio access network (RAN), a wireless access network function or a wireless access network unit. The access network device 12 may include a base station, a wireless local area network (WLAN) access point, or a WiFi node, etc. The base station may be called a node B, an evolved Node B (eNB), an access point, a base transceiver station (BTS), a radio base station, a radio transceiver, a basic service set (BSS), an extended service set (ESS), a home node B, a home evolved node B, a transmitting receiving point (TRP) or another appropriate term in the art, the base station is not limited to a specific technical term as long as the same technical effects are achieved, and it needs to be noted that in the embodiments of the present application, introduction is made only by taking a base station in the NR system as an example without limiting the specific type of the base station.

For example, taking the NR system as an example, its parameters are as follows: a frequency band is 2.6 G, a bandwidth is 100 M, a system mode is time division duplexing (TDD), a subcarrier spacing is configured to be 30 kHz, the number of user equipment (UE) is 1, the number of receiving antennas is 32, the number of transmitting antennas is 1, the number of resource blocks (RBs) distributed by the UE is 273, the number of symbols distributed by the UE is 12, the number of resource element (RE) data on each RB is 12, and a type of a demodulation reference signal (DMRS) is type A.

A data processing method provided by an embodiment of the present application is described in detail below through some embodiments and application scenarios with reference to the accompanying drawings.

As shown in FIG. 2, an embodiment of the present application provides a data processing method 200. The method may be performed by a terminal device. In other words, the method may be performed by software or hardware mounted on the terminal device. The method includes the following steps.

Step S201: spatial decomposition is performed on received data of a plurality of receiving antennas to obtain a plurality of sub-spaces.

Specifically, the spatial decomposition and reconstruction are performed on the received data received by the plurality of receiving antennas, and performing the spatial decomposition on the received data of the plurality of receiving antennas may adopt, for example, an eigen decomposition (EVD), a singular value decomposition (SVD), a quadrature rectangle (QR) decomposition, Schmidt orthogonalization or other manners.

In a possible implementation, performing the spatial decomposition on the received data of the plurality of receiving antennas includes:
converting the received data to a frequency domain to obtain frequency-domain received data, calculating a covariance matrix of the frequency-domain received data according to resource elements of the plurality of receiving antennas, and performing first decomposition processing on the covariance matrix to obtain the plurality of sub-spaces.

Specifically, Fourier transform and removal of cyclic prefix (removal of CP) and other related processing may be performed on the received data to obtain the frequency-domain received data. For the frequency-domain received data, its dimension may be a product by multiplying the number of RBs distributed by UE, the number of symbols distributed by the UE, the number of REs on each RB and the number of the receiving antennas. For example, taking the parameters of the above NR system as an example, the number of the RBs distributed by the UE, the number of the symbols distributed by the UE, the number of the REs on each RB and the number of the receiving antennas are respectively 273, 12, 12 and 32, so the obtained dimension of the frequency-domain received data is (273×12×12)×32=45864×32.

In a possible implementation, the covariance matrix of the frequency-domain received data may be calculated according to the following formula:

$$R = cov ( Y ) = \frac{1}{{N}_{re}} {\sum }_{i = 0}^{{N}_{re} - 1} {Y}_{i}^{H} {Y}_{i}$$

where R is the covariance matrix, Nᵣₑ is the number of the resource elements of the plurality of receiving antennas, Yᵢ is a vector composed of the resource elements on the plurality of receiving antennas, and Y is the received data of the plurality of receiving antennas.

For example, according to the above given parameters of the NR system, Nᵣₑ may be 273×12=3276. For 32 antennas, a dimension of each Yᵢ is 1×32, and the finally obtained covariance matrix R is a symmetric matrix 32×32.

The first decomposition processing includes one of the following:
(1) singular value decomposition (SVD) processing; and
(2) quadrature rectangle decomposition processing.

Further, performing, in a case that the first decomposition processing includes the above (1) singular value decomposition processing, the first decomposition processing on the covariance matrix includes: performing the first decomposition processing according to the following formula:

$$[ U , S , V ] = svd ( R )$$

where R is the covariance matrix, U is a left singular matrix, V is a right singular matrix, each column of V is a sub-space, and each column is a weighting coefficient of the received data of the plurality of receiving antennas.
performing, in a case that the first decomposition processing includes the above (2) quadrature rectangle decomposition processing, the first decomposition processing on the covariance matrix includes: performing the first decomposition processing according to the following formula:

$$[ Q , T ] = qr ( R )$$

where R is the covariance matrix, Q is an orthogonal matrix, T is an upper triangular matrix, Q represents a sub-space after decomposition, and each column of Q may be used as a sub-space.

Steps S203: signal quality of at least one sub-space is measured.

Specifically, each column in the above V matrix may be used as a sub-space, when the signal quality of the at least one sub-space is measured, the signal quality of the at least one sub-space may be measured through a signal to noise ratio of a channel estimation value of each sub-space or maximum power of each sub-space, the signal to noise ratio of the channel estimation value or the maximum power may be used to represent the signal quality of the sub-space, and the larger values of the signal to noise ratio of the channel estimation value or the maximum power is, the better the signal quality of the sub-space is.

Step S205: a target sub-space is selected from the plurality of sub-spaces according to the signal quality of the sub-space.

Specifically, by means of a measurement quantity of the signal quality in the above step, the target sub-space with a better signal is found from the plurality of sub-spaces.

Step S207: the received data is processed through the target sub-space.

Specifically, spatial filtering processing is performed through the target sub-space to obtain received data in the target sub-space, so as to filter the received data and achieve a purpose of performing dimensionality reduction on the received data, and after the received data is subjected to filtering and dimensionality reduction, the received data in the target sub-space is obtained and subjected to subsequent processing, such as channel estimation processing, equalization processing, demodulation processing, bit-level descrambling processing, rate de-matching processing, decoding processing, de-CRC processing and the like.

According to the data processing method provided by the embodiment of the present application, the spatial decomposition is performed on the received data of the plurality of receiving antennas to obtain the plurality of sub-spaces; the signal quality of the at least one sub-space is measured; the target sub-space is selected from the plurality of sub-spaces according to the signal quality of the sub-space; and the received data is processed by means of the target sub-space, so the received data can be processed by using the selected target sub-space, thus the received data is filtered, useless data is discarded, dimensionality of the received data is reduced, and complexity and energy consumption of processing the received data by a receiver are reduced during a subsequent processing process.

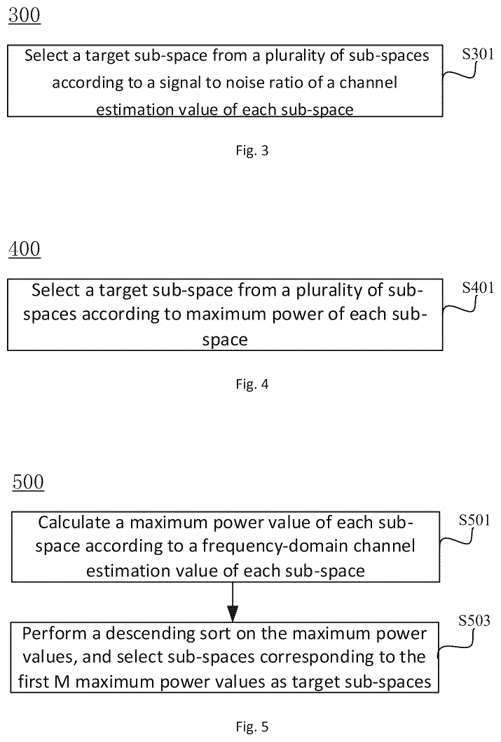

In a possible implementation, as shown in FIG. 3, in another data processing method 300, selecting the target sub-space from the plurality of sub-spaces according to the signal quality of the sub-space includes the following steps.

Step S301: the target sub-space is selected from the plurality of sub-spaces according to a signal to noise ratio of a channel estimation value of each sub-space.

Specifically, by using the signal to noise ratio of the channel estimation value of each sub-space as a measurement quantity for measuring the signal quality of each sub-space, the target sub-space with the better signal is selected out.

Selecting the target sub-space from the plurality of sub-spaces according to the signal to noise ratio of the channel estimation value of each sub-space includes: selecting a sub-space of which a signal to noise ratio of a channel estimation value is greater than a threshold value as the target sub-space.

The threshold value may be determined according to a mean value of the signal to noise ratios of the channel estimation values of the plurality of sub-spaces.

Specifically, the mean value ΔNRₘₑₐₙ of the signal to noise ratios of the channel estimation values of the sub-spaces may be calculated according to the following formula: ΔNRₘₑₐₙ=mean(ANR_{h,j}) when the threshold value is determined, an integer multiple of the mean value ANRₘₑₐₙ of the signal to noise ratios may be used as the threshold value, for example, N may be a value of 2, then the threshold value Thrₐₙᵣ may be represented as the following formula: Thrₐₙᵣ=2ANRₘₑₐₙ, all indexes in which ANR_{h,j} is greater than the threshold value are found in all the sub-spaces to obtain a set Index, where Index=find(ANR_{h,j}>Thrₐₙᵣ), then columns corresponding to the indexes in the set Index are taken from the above V matrix as better target sub-spaces, for example, the set Index includes two indexes in which ANR_{h,j} is greater than the threshold value, then columns corresponding to the two indexes are taken from the V matrix as the target sub-spaces, and a dimension of a set Gs of the target sub-spaces is 32×2, which may be specifically represented by using the following formula: Gₛ=V(:,Index).

After Gs is obtained, spatial filtering processing is performed on all the receiving antennas and a set of target sub-spaces obtained by searching, so as to obtain the received data′ᵣₓ of the target sub-spaces, which may be specifically as the following formula: data′ᵣₓ=dataᵣₓGₛ, where dataᵣₓ is the received data received by the receiving antennas.

In a possible implementation, the signal to noise ratio of the channel estimation value is calculated through the following formula:

$${ANR}_{h , j} = \frac{max ( {\vert {hf}_{j}^{time} \vert}^{2} )}{mean ( {\vert {hf}_{j}^{time} \vert}^{2} )}$$

where ANR_{h,j} is the signal to noise ratio of the channel estimation value of the jₜₕ sub-space,

$${hf}_{j}^{time}$$

is a time-domain channel estimation value of the jₜₕ sub-space after denoising,

$$max ( {\vert {hf}_{j}^{time} \vert}^{2} )$$

is a maximum value of a modulus of

$${\vert {hf}_{j}^{time} \vert}^{2} , and mean ( {\vert {hf}_{j}^{time} \vert}^{2} )$$

is a mean value of

$${\vert {hf}_{j}^{time} \vert}^{2} .$$

In a possible implementation, the time-domain channel estimation value

$${hf}_{j}^{time}$$

is calculated through the following formula:

$${hf}_{j}^{time} = filter ( {hf}^{time} )$$

where hf^{time} is a time-domain channel estimation value before denoising, where hf^{time} is obtained by converting a frequency-domain channel estimation value to a time domain.

In a possible implementation, the frequency-domain channel estimation value is calculated through the following manner:
target demodulation reference signals of the plurality of receiving antennas on each sub-space are calculated according to demodulation reference signals of the plurality of receiving antennas and a weighting coefficient in each sub-space; and a channel estimation is performed on the target demodulation reference signal of each sub-space to obtain the frequency-domain channel estimation value of each sub-space.

Specifically, the target demodulation reference signal is calculated through the following formula:

$${data}_{dmrs}^{′} = {data}_{dmrs} \cdot G$$

where data_{dmrs} is the demodulation reference signal, G is the weighting coefficient in the sub-space, and data′_{dmrs} is the target demodulation reference signal.

For example, as for the above V matrix, a weighting coefficient of the current sub-space in the V matrix is taken out, as for one sub-space, the weighting coefficient in the sub-space may be taken out through the formula G=V(:,j), where j refers to an index of the current sub-space, and by using the above given parameters of the NR system, the number of the receiving antennas is 32, so the taken-out G of the current sub-space is a 32×1 vector.

For another example, as for the above NR system taken as an example, the number of the RBs distributed by the UE is 273, the number of the REs on each RB of the UE is 12, the number of the receiving antennas is 32, the number of the demodulation reference signals on all the receiving antennas is 273×12±2=1638, a data dimension of the demodulation reference signals is 1638×32, and a target demodulation reference signal obtained by multiplying the demodulation reference signals by G is a vector of 1638×1.

In a possible implementation, the frequency-domain channel estimation value is calculated through the following formula:

$${H}_{j}^{freq} = {data}_{dmrs}^{′} conj ( pilot )$$

where

$${H}_{j}^{freq}$$

is the frequency-domain channel estimation value, pilot is a pilot frequency sequence, and conj(pilot) is a conjugate of the pilot frequency sequence.

Specifically, pilot is a pilot frequency sequence generated according to system parameters of an NR system, for example, a dimension of the pilot frequency sequence generated according to the parameters of the above NR system is 1638×1.

In a possible implementation, as shown in FIG. 4, in another data processing method 400, selecting the target sub-space from the plurality of sub-spaces according to the signal quality of the sub-space includes the following steps.

Step S401: the target sub-space is selected from the plurality of sub-spaces according to the maximum power of each sub-space.

Specifically, by using the maximum power of each sub-space as a measurement quantity for measuring the signal quality of each sub-space, the target sub-space with the better signal is selected out.

In a possible implementation, as shown in FIG. 5, in another data processing method 500, selecting the target sub-space from the plurality of sub-spaces according to the maximum power of each sub-space includes the following steps.

Step S501: a maximum power value of each sub-space is calculated according to a frequency-domain channel estimation value of each sub-space.

In a possible implementation, the maximum power value is calculated through the following formula:

$${P}_{H , j} = max ( {\vert {H}_{j}^{freq} \vert}^{2} )$$

where

$${H}_{j}^{freq}$$

is the frequency-domain channel estimation value, and P_{H,j} is the maximum power value.

Step S503: a descending sort is performed on the maximum power values, and sub-spaces corresponding to the first M maximum power values are selected as the target sub-spaces.

Specifically, P_{H,j} is sorted according to a sequence from large to small, M columns with the highest energy are taken, a value of M is determined according to the number of transport blocks of each time of transmission or according to the number of the receiving antennas and the number of the transport blocks of each time of transmission, more specifically, a value range of M may be a fluxion~min (the number of the receiving antennas, the fluxion+2), where the fluxion is the number of the transport blocks (TBs) of each time of transmission, min (the number of the receiving antennas, the fluxion+2) represents a minimum value in “the number of the receiving antennas” and “the fluxion+2”, a value of M is located in an interval defined by the number of the TBs of each time of transmission and min (the number of the receiving antennas, the fluxion+2), for example, when M is 1, and the number of the receiving antennas is 32, the dimension of the selected target sub-space is 32×1, which may be represented by using the following formula: Gₛ=V(:,Index(1)).

It needs to be noted that according to the data processing method provided by the embodiment of the present application, an executive body may be a data processing apparatus, and in the embodiment of the present application, by taking the data processing apparatus performing and loading the data processing method as an example, the data processing apparatus provided by the embodiment of the present application is described.

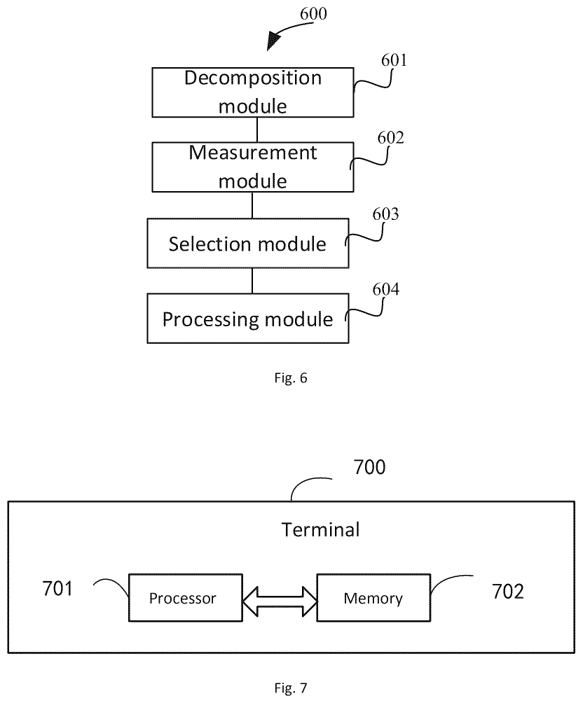

FIG. 6 is a schematic structural diagram of a data processing apparatus of an embodiment of the present application. As shown in FIG. 6, the data processing apparatus 600 includes: a decomposition module 601, configured to perform spatial decomposition on received data of a plurality of receiving antennas to obtain a plurality of sub-spaces; a measurement module 602, configured to measure signal quality of at least one sub-space; a selection module 603, configured to select a target sub-space from the plurality of sub-spaces according to the signal quality of the sub-space; and a processing module 604, configured to process the received data through the target sub-space.

In the embodiment of the present application, the spatial decomposition is performed on the received data of the plurality of receiving antennas to obtain the plurality of sub-spaces, the signal quality of the at least one sub-space is measured, the target sub-space is selected from the plurality of sub-spaces according to the signal quality of the sub-space, and the received data is processed by means of the target sub-space, so the received data can be processed by using the selected target sub-space, thus the received data is filtered, useless data is discarded, dimensionality of the received data is reduced, and complexity and energy consumption of processing the received data by a receiver are reduced during a subsequent processing process.

In a possible implementation, the decomposition module 601 is further configured to convert the received data to a frequency domain to obtain frequency-domain received data, calculate a covariance matrix of the frequency-domain received data according to resource elements of the plurality of receiving antennas, and perform first decomposition processing on the covariance matrix to obtain a plurality of sub-spaces.

In a possible implementation, the first decomposition processing includes a singular value decomposition processing, and the decomposition module 601 is further configured to perform the first decomposition processing according to the following formula:

$$[ U , S , V ] = svd ( R )$$

where R is the covariance matrix, U is a left singular matrix, each column of V is one sub-space, and each column is a weighting coefficient of the received data of the plurality of receiving antennas.

In a possible implementation, the first decomposition processing includes a quadrature rectangle decomposition processing, and the decomposition module 601 is further configured to perform the first decomposition processing according to the following formula:

$$[ Q , T ] = qr ( R )$$

where R is the covariance matrix, Q is an orthogonal matrix, and T is an upper triangular matrix.

In a possible implementation, the covariance matrix is calculated through the following formula:

$$R = cov ( Y ) = \frac{1}{{N}_{re}} {\sum }_{i = 0}^{{N}_{re} - 1} {Y}_{i}^{H} {Y}_{i}$$

where Nᵣₑ is the number of the resource elements of the plurality of receiving antennas, Yᵢ is a vector composed by the resource elements on the plurality of receiving antennas, and Y is the received data of the plurality of receiving antennas.

In a possible implementation, the selection module 603 is further configured to select the target sub-space from the plurality of sub-spaces according to a signal to noise ratio of a channel estimation value of each sub-space.

In a possible implementation, the selection module 603 is further configured to select the target sub-space from the plurality of sub-spaces according to maximum power of each sub-space.

In a possible implementation, the selection module 603 is further configured to select a sub-space of which a signal to noise ratio of a channel estimation value is greater than a threshold value as the target sub-space.

The signal to noise ratio of the channel estimation value is calculated through the following formula:

$${ANR}_{h , j} = \frac{max ( {\vert {hf}_{j}^{time} \vert}^{2} )}{mean ( {\vert {hf}_{j}^{time} \vert}^{2} )}$$

where ANR_{h,j} is the signal to noise ratio of the channel estimation value of the jₜₕ sub-space,

$${hf}_{j}^{time}$$

is a time-domain channel estimation value of the jₜₕ sub-space after denoising,

$$max ( {\vert {hf}_{j}^{time} \vert}^{2} )$$

is a maximum value of a modulus of

$${\vert {hf}_{j}^{time} \vert}^{2} , and mean ( {\vert {hf}_{j}^{time} \vert}^{2} )$$

is a mean value of

$${\vert {hf}_{j}^{time} \vert}^{2} .$$

In a possible implementation, the time-domain channel estimation value

$${hf}_{j}^{time}$$

is calculated through the following formula:

$${hf}_{j}^{time} = filter ( {hf}^{time} )$$

where hf^{time} is a time-domain channel estimation value before denoising, where hf^{time} is obtained by converting a frequency-domain channel estimation value to a time domain.

In a possible implementation, the frequency-domain channel estimation value is calculated through the following manner:
target demodulation reference signals of the plurality of receiving antennas on each sub-space are calculated according to demodulation reference signals of the plurality of receiving antennas and a weighting coefficient in each sub-space; and a channel estimation is performed on the target demodulation reference signal of each sub-space to obtain the frequency-domain channel estimation value of each sub-space.

In a possible implementation, the target demodulation reference signal is calculated through the following formula:

$${data}_{dmrs}^{′} = {data}_{dmrs} \cdot G$$

where data_{dmrs} is the demodulation reference signal, G is the weighting coefficient in the sub-space, and data′_{dmrs} is the target demodulation reference signal.

The frequency-domain channel estimation value is calculated through the following formula:

$${H}_{j}^{freq} = {data}_{dmrs}^{′} conj ( pilot )$$

where

$${H}_{j}^{freq}$$

is the frequency-domain channel estimation value, pilot is a pilot frequency sequence, and conj(pilot) is a conjugate of the pilot frequency sequence.

In a possible implementation, the threshold value is determined according to a mean value of signal to noise ratios of channel estimation values of the plurality of sub-spaces.

In a possible implementation, the selection module 603 is further configured to calculate a maximum power value of each sub-space according to the frequency-domain channel estimation value of each sub-space; and perform a descending sort on the maximum power values, and select sub-spaces corresponding to the first M maximum power values as target sub-spaces, where a value of M is determined according to the number of transport blocks of each time of transmission or according to the number of the receiving antennas and the number of the transport blocks of each time of transmission.

In a possible implementation, the maximum power value is calculated through the following formula:

$${P}_{H , j} = max ( {\vert {H}_{j}^{freq} \vert}^{2} )$$

where

$${H}_{j}^{freq}$$

is the frequency-domain channel estimation value, and P_{H,j} is the maximum power value.

The data processing apparatus in the embodiment of the present application may be an electronic device, for example, an electronic device with an operating system, or a part, for example, an integrated circuit or a chip in the electronic device. The electronic device may be a terminal or another device besides the terminal. Exemplarily, the terminal may include but is not limited to the above listed types of the terminal 11, and the another device may be a server, a network attached storage (NAS), etc., which is not limited specifically by the embodiment of the present application.

The data processing apparatus provided by the embodiment of the present application can implement all flows implemented by the method embodiment of FIG. 2 to FIG. 5, and achieve the same technical effects, which is not described in detail here for avoiding repetitions.

Optionally, as shown in FIG. 7, an embodiment of the present application further provides a terminal 700, including a processor 701 and a memory 702, the memory 702 stores a program or an instruction capable of running on the processor 701, and the program or the instruction, when executed by the processor 701, implements all steps of the embodiment of the above data processing method, which can achieve the same technical effects.

An embodiment of the present application further provides a readable storage medium, the readable storage medium stores a program or an instruction, and the program or the instruction, when executed by a processor, implements all flows of the embodiment of the above data processing method, which can achieve the same technical effects and is not described in detail here for avoiding repetitions.

The processor is a processor in the terminal in the above embodiment. The readable storage medium includes a computer-readable storage medium, for example, a computer read only memory (ROM), a random access memory (RAM), a magnetic disk, an optical disc or the like.

An embodiment of the present application further provides a chip, the chip includes a processor and a communication interface, the communication interface is coupled to the processor, and the processor is configured to run a program or an instruction to implement all flows of the embodiment of the above data processing method, which can achieve the same technical effects and is not described here in detail for avoiding repetitions.

It is to be understood that the chip mentioned in the embodiment of the present application may also be called a system-on-a-chip or the like.

An embodiment of the present application further provides a computer program/program product, the computer program/program product is stored in a storage medium, and the computer program/program product is executed by at least one processor so as to implement all flows of the embodiment of the above data processing method, which can achieve the same technical effects, and is not described here in detail for avoiding repetitions.

It needs to be noted that a term “comprise”, “include” or any other variant thereof herein intends to cover a non-exclusive inclusion, so that a process, a method, a product or an apparatus including a series of elements includes not only those elements, but also includes other elements not listed clearly or further includes inherent elements of this process, method, product or apparatus. Without more limitations, an element defined by the sentence “including one . . . ” does not exclude that there are still other same elements in the process, method, product, or apparatus including the element. Besides, it needs to be noted that the scope of the method and the apparatus in implementations of the present application is not limited to executing functions according to a shown or discussed sequence, it may also include that functions are executed in a basically simultaneously mode or in an opposite sequence according to the involved functions, for example, the described method may be executed in an order different from the described one, and various steps may also be added, omitted, or combined. In addition, features described with reference to some examples may be combined in other examples.

According to the descriptions in the foregoing implementations, those skilled in the art may clearly learn that the method according to the foregoing embodiment may be implemented by relying on software and a necessary general-purpose hardware platform or certainly by using hardware, but in most of cases, the former is the better implementation. Based on such an understanding, the technical solutions of the present application essentially, or the part contributing to the prior art, may be presented in the form of a computer software product. The computer software product is stored in a storage medium (for example, an ROM/RAM, a magnetic disk, or an optical disc), including several instructions to enable a terminal (which may be a mobile phone, a computer, a server, an air-conditioner, a network device, or the like) to perform the method described in the embodiments of the present application.

The embodiments of the present application have been described above with reference to the accompanying drawings. The present application is not limited to the specific implementations described above, and the specific implementations described above are merely exemplary and not limitative. Those ordinarily skilled in the art may also make various variations under the revelation of the present application without departing from the intention of the present application and the protection scope of the claims, and such variations shall all fall within the protection scope of the present application.

1. A data processing method, comprising:
performing spatial decomposition on received data of a plurality of receiving antennas to obtain a plurality of sub-spaces;
measuring signal quality of at least one sub-space;
selecting a target sub-space from the plurality of sub-spaces according to the signal quality of the sub-space; and
processing the received data through the target sub-space.

2. The method according to claim 1, wherein performing the spatial decomposition on the received data of the plurality of receiving antennas comprises:
converting the received data to a frequency domain to obtain frequency-domain received data; and
calculating a covariance matrix of the frequency-domain received data according to resource elements of the plurality of receiving antennas, and performing first decomposition processing on the covariance matrix to obtain the plurality of sub-spaces.

3. The method according to claim 2, wherein the first decomposition processing comprises singular value decomposition processing, and performing the first decomposition processing on the covariance matrix comprises:
performing the first decomposition processing according to the following formula:
$$[ U , S , V ] = svd ( R )$$
wherein R is the covariance matrix, U is a left singular matrix, each column of V is one sub-space, and each column is a weighting coefficient of the received data of the plurality of receiving antennas.

4. The method according to claim 2, wherein the first decomposition processing comprises quadrature rectangle decomposition processing, and performing the first decomposition processing on the covariance matrix comprises:
performing the first decomposition processing according to the following formula:
$$[ Q , T ] = qr ( R )$$
wherein R is the covariance matrix, Q is an orthogonal matrix, and T is an upper triangular matrix.

5. The method according to claim 2, wherein the covariance matrix is calculated through the following formula:
$$R = cov ( Y ) = \frac{1}{{N}_{re}} {\sum }_{i = 0}^{{N}_{re} - 1} {Y}_{i}^{H} {Y}_{i}$$
wherein R is the covariance matrix, Nᵣₑ is the number of the resource elements of the plurality of receiving antennas, Yᵢ is a vector composed of the resource elements on the plurality of receiving antennas, and Y is the received data of the plurality of receiving antennas.

6. The method according to claim 1, wherein selecting the target sub-space from the plurality of sub-spaces according to the signal quality of the sub-space comprises:
selecting the target sub-space from the plurality of sub-spaces according to a signal to noise ratio of a channel estimation value of each sub-space.

7. The method according to claim 1, wherein selecting the target sub-space from the plurality of sub-spaces according to the signal quality of the sub-space comprises:
selecting the target sub-space from the plurality of sub-spaces according to maximum power of each sub-space.

8. The method according to claim 6, wherein selecting the target sub-space from the plurality of sub-spaces according to the signal to noise ratio of the channel estimation value of each sub-space comprises:
selecting a sub-space of which a signal to noise ratio of a channel estimation value is greater than a threshold value as the target sub-space;
wherein the signal to noise ratio of the channel estimation value is calculated through the following formula:
$${ANR}_{h , j} = \frac{max ( {\vert {hf}_{j}^{time} \vert}^{2} )}{mean ( {\vert {hf}_{j}^{time} \vert}^{2} )}$$
wherein ANR_{h,j} is the signal to noise ratio of the channel estimation value of the jₜₕ sub-space,
$${hf}_{j}^{time}$$
is a time-domain channel estimation value of the jₜₕ sub-space after denoising,
$$max ( {\vert {hf}_{j}^{time} \vert}^{2} )$$
is a maximum value of a modulus of
$${\vert {hf}_{j}^{time} \vert}^{2} , and mean ( {\vert {hf}_{j}^{time} \vert}^{2} )$$
is a mean value of
$${\vert {hf}_{j}^{time} \vert}^{2} .$$

9. The method according to claim 8, wherein the time-domain channel estimation value
$${hf}_{j}^{time}$$
is calculated through the following formula:
$${hf}_{j}^{time} = filter ( {hf}^{time} )$$
wherein hf^{time} is a time-domain channel estimation value before denoising, wherein hf^{time} is obtained by converting a frequency-domain channel estimation value to a time domain.

10. The method according to claim 9, wherein the frequency-domain channel estimation value is calculated through the following manner:
target demodulation reference signals of the plurality of receiving antennas on each sub-space are calculated according to demodulation reference signals of the plurality of receiving antennas and a weighting coefficient in each sub-space; and
a channel estimation is performed on the target demodulation reference signal of each sub-space to obtain the frequency-domain channel estimation value of each sub-space.

11. The method according to claim 10, wherein the target demodulation reference signal is calculated through the following formula:
$${data}_{dmrs}^{′} = {data}_{dmrs} \cdot G$$
wherein data_{dmrs} is the demodulation reference signal, G is the weighting coefficient in the sub-space, and data′_{dmrs} is the target demodulation reference signal; and
the frequency-domain channel estimation value is calculated through the following formula:
$${H}_{j}^{freq} = {data}_{dmrs}^{′} conj ( pilot )$$
wherein
$${H}_{j}^{freq}$$
is the frequency-domain channel estimation value, pilot is a pilot frequency sequence, and conj(pilot) is a conjugate of the pilot frequency sequence.

12. The method according to claim 8, wherein the threshold value is determined according to a mean value of the signal to noise ratios of the channel estimation values of the plurality of sub-spaces.

13. The method according to claim 7, wherein selecting the target sub-space from the plurality of sub-spaces according to the maximum power of each sub-space comprises:
calculating a maximum power value of each sub-space according to a frequency-domain channel estimation value of each sub-space; and
performing a descending sort on the maximum power values, and selecting sub-spaces corresponding to the first M maximum power values as target sub-spaces, wherein a value of M is determined according to the number of transport blocks of each time of transmission or according to the number of the receiving antennas and the number of the transport blocks of each time of transmission.

14. The method according to claim 13, wherein the maximum power value is calculated through the following formula:
$${P}_{H , j} = max ( {\vert {H}_{j}^{freq} \vert}^{2} )$$
wherein
$${H}_{j}^{freq}$$
is the frequency-domain channel estimation value, and P_{H,j} is the maximum power value.

15. A terminal, comprising a processor and a memory, wherein the memory stores a program or an instruction capable of running on the processor, and the program or the instruction, when executed by the processor, implements the steps of the data processing method according to claim 1.

16. A non-transitory readable storage medium, storing a program or an instruction, wherein the program or the instruction, when executed by a processor, implements the steps of the data processing method according to claim 1.
